(19) United States
(12) Patent Application Publication
(10) Pub. No.: US 2004/0168334 A1
(43) Pub. Date: Sep. 2, 2004

(54) Roof tile measuring system

(76) Inventor: Tom L. Tripp, Coeur D'Alene, ID (US)

Correspondence Address: Michael S. Neustel, Suite No. 4, 2534 South University Drive, Fargo, ND, 58103, US

(21) Appl. No.: 10/377,463

(22) Filed: Feb. 27, 2003

(51) Int. Cl. G01B 3/10

(52) U.S. Cl. 33/759

(57) ABSTRACT

A roof tile measuring system for efficiently and accurately installing roof tile to a roof structure. The roof tile measuring system includes an elongate member, a plurality of horizontal markings for horizontal tile, and a plurality of vertical markings for vertical tile. The horizontal markings and vertical marking each have groups of specific markings wherein each group indicates a desired course exposure. The groups of markings preferably have a different design and/or color thereby clearly indicating the group along the entire length of the elongate member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to roof tile installation systems and more specifically it relates to a roof tile measuring system for efficiently and accurately installing roof tile to a roof structure.

2. Description of the Related Art

Conventional methods of installing roof tile comprise starting the installation with a bottom row (or a side column) at the lower edge of the roof and continuing with additional rows stacked upon one another until the entire roof surface is covered with roof tile. When installing the additional rows or columns of roof tile, the user typically selects a desired spacing and utilizes this spacing measurement for all rows.

The main problem with conventional roof tile installation systems is that they do not adequately apply roof tile to a roof surface. Conventional roof tile installation system often times result in miscalculations with the upper row having to be a relatively small row thereby decreasing the overall appearance of the roof. Another problem with conventional roof tile installation systems is that the rows may become easily misaligned which becomes very conspicuous to observers after the roof tiles have been completely installed. Another problem with conventional roof tile installation systems is that mistakes made early in the installation process can result in costly repairs having to be made to the roof and in some instances complete removal of the roof tile.

Examples of patented devices which may be related to the present invention include U.S. Pat. No. 5,056,234 to Han; U.S. Pat. No. 5,337,487 to Mangino, Sr.; U.S. Pat. No. 1,677,821 to Graham; U.S. Pat. No. 5,404,651 to Brodrick; U.S. Pat. No. 3,210,850 to Grzyb; U.S. Pat. No. 5,913,586 to Marshall; U.S. Pat. No. 5,724,747 to Poorman; and U.S. Pat. No. 4,149,320 to Troyer et al.

While these devices may be suitable for the particular purpose to which they address, they are not as suitable for efficiently and accurately installing roof tile to a roof structure. Conventional roof tile installation system often times result in misaligned roof tiles which can be unsightly and costly.

In these respects, the roof tile measuring system according to the present invention substantially departs from the conventional concepts and designs of the prior art, and in so doing provides an apparatus primarily developed for the purpose of efficiently and accurately installing roof tile to a roof structure.

### BRIEF SUMMARY OF THE INVENTION

In view of the foregoing disadvantages inherent in the known types of roof tile installation systems now present in the prior art, the present invention provides a new roof tile measuring system construction wherein the same can be utilized for efficiently and accurately installing roof tile to a roof structure.

The general purpose of the present invention, which will be described subsequently in greater detail, is to provide a new roof tile measuring system that has many of the advantages of the roof tile installation systems mentioned heretofore and many novel features that result in a new roof tile measuring system which is not anticipated, rendered obvious, suggested, or even implied by any of the prior art roof tile installation systems, either alone or in any combination thereof.

To attain this, the present invention generally comprises an elongate member, a plurality of horizontal markings for horizontal tile, and a plurality of vertical markings for vertical tile. The horizontal markings and vertical marking each have groups of specific markings wherein each group indicates a desired course exposure. The groups of markings preferably have a different design and/or color thereby clearly indicating the group along the entire length of the elongate member.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a roof tile measuring system that will overcome the shortcomings of the prior art devices.

A second object is to provide a roof tile measuring system for efficiently and accurately installing roof tile to a roof structure.

Another object is to provide a roof tile measuring system that assists in the creation of properly aligned and aesthetically pleasing roof tile roofs.

An additional object is to provide a roof tile measuring system that can be utilized for horizontal rows or vertical columns of roof tile.

A further object is to provide a roof tile measuring system that may be utilized with various different sizes, styles and spacing of roof tile.

Another object is to provide a roof tile measuring system that is simple and easy to utilize for workers.

A further object is to provide a roof tile measuring system that reduces the amount of time required to install roof tile upon a roof.

Another object is to provide a roof tile measuring system that accurately and equally spaces the roof tile.

A further object is to provide a roof tile measuring system that automatically determines a course (i.e. exposure) of the tiles.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a top view of the present invention extending longitudinally from the lower edge to the upper edge of the roof.

FIG. 2 is a top view of the present invention extending at an angle from the lower edge to the upper edge with the desired marking positioned at the upper edge.

FIG. 3 is a top view of the present invention extending longitudinally from a first side to a second side of the roof.

FIG. 4 is a top view of the present invention extending at an angle from the first side to the second side with the desired marking positioned at the second side.

FIG. 5 is a top view of the present invention illustrating the various markings.

FIG. 6 is a magnified top view of the present invention illustrating the various markings.

FIG. 7 is another magnified top view of the present invention illustrating the various markings.

FIG. 8 is an upper perspective view of the present invention with an exemplary housing unit.

FIG. 9 is a top view of the present invention extending longitudinally from the lower edge to the upper edge of the roof at an angle.

FIG. 10 is a top view of the present invention extending at an angle from the first side to the second side with the desired marking positioned at the second side.

### DETAILED DESCRIPTION OF THE INVENTION

A. Overview

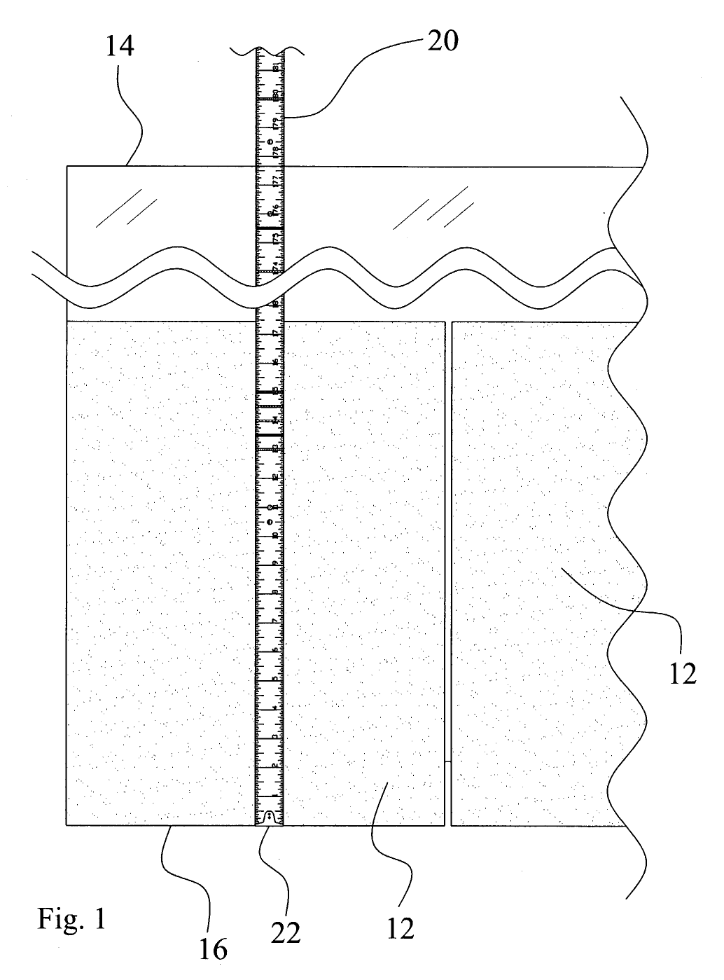

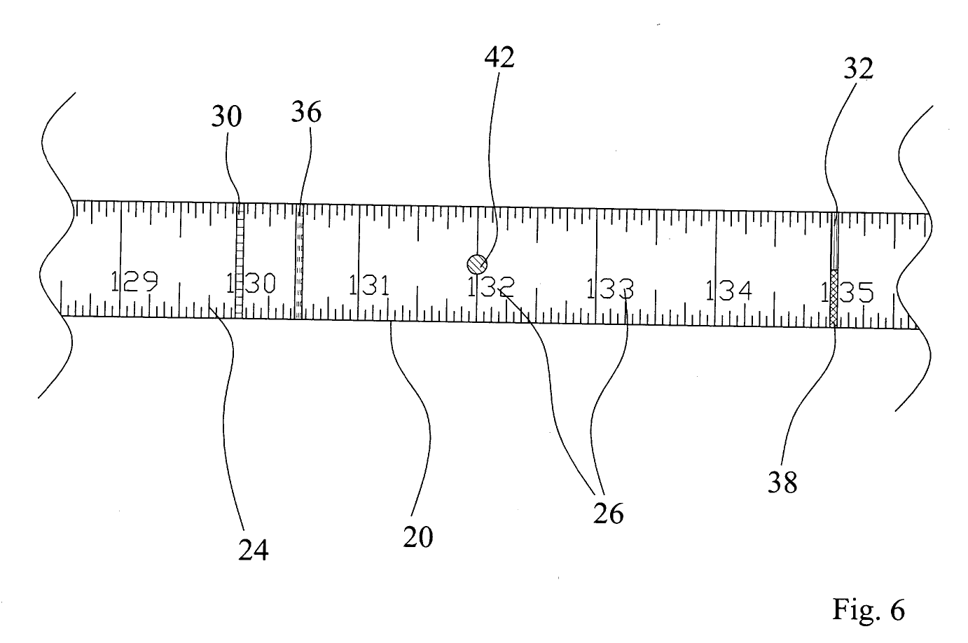

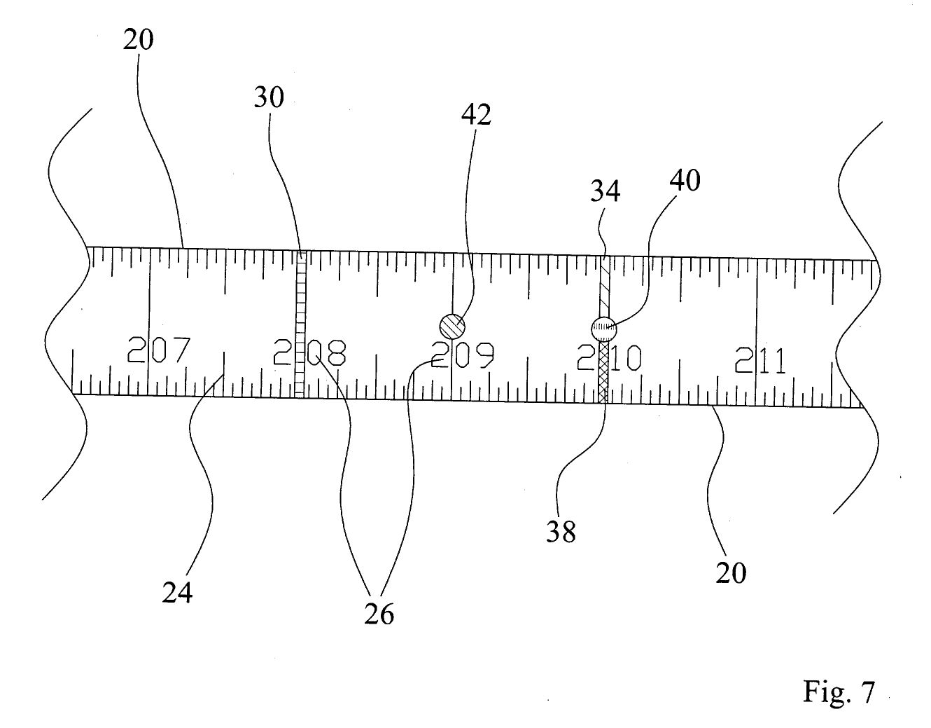

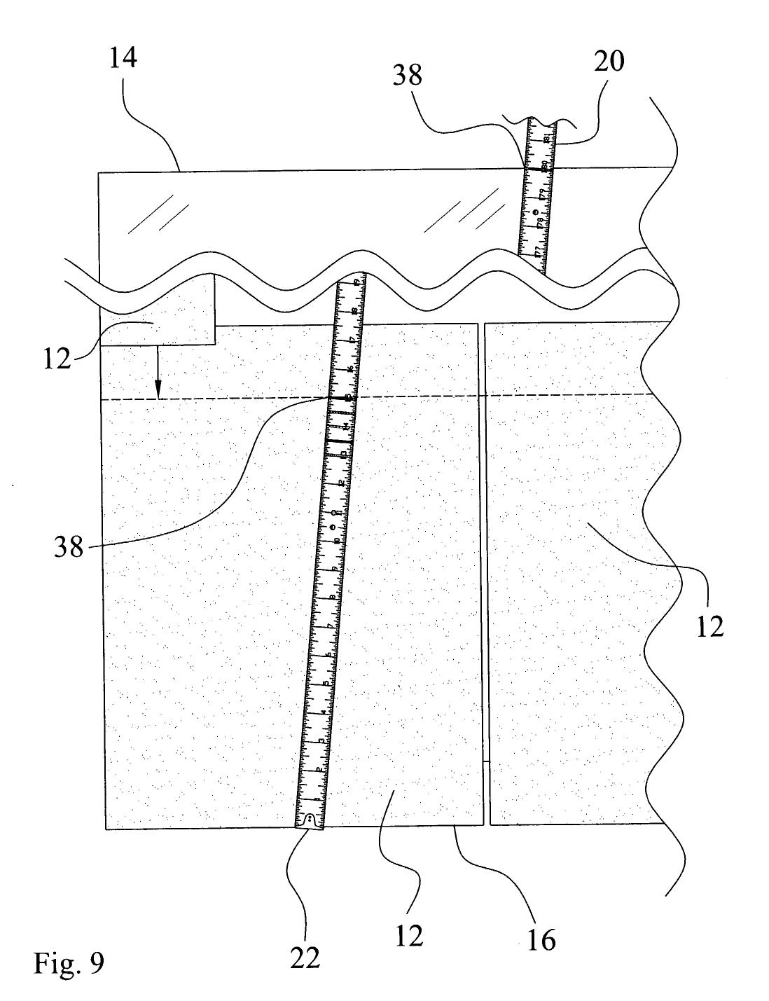

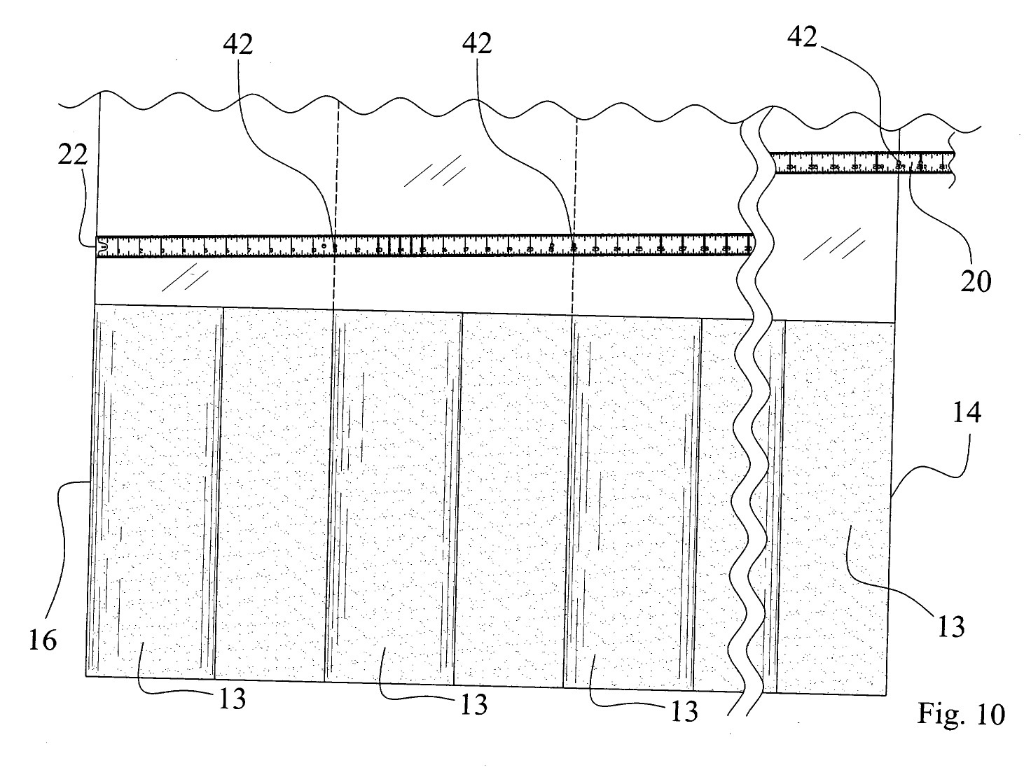

Turning now descriptively to the drawings, in which similar reference characters denote similar elements throughout the several views, FIGS. 1 through 10 illustrate a roof tile measuring system 10, which comprises an elongate member 20, a plurality of horizontal marks 30, 32, 34, 36, 38 for horizontal tile 12, and a plurality of vertical marks 40, 42 for vertical tile 13. The horizontal marks 30, 32, 34, 36, 38 and vertical marks 40, 42 each have groups of specific markings wherein each group indicates a desired course exposure. The groups of markings preferably have a different design and/or color thereby clearly indicating the group along the entire length of the elongate member 20. It can be appreciated that the horizontal marks 30, 32, 34, 36, 38 may be positioned upon the elongate member 20 independently of the vertical marks 40, 42 and vice-versa.

B. Elongate Member

FIGS. 1 through 7 of the drawings illustrate the elongate member 20. The elongate member 20 is preferably comprised of a spring steel material with a U-shaped structure commonly utilized within conventional tape measures. However, the elongate member 20 may be comprised of various other materials and structures capable of being extended in an elongate manner.

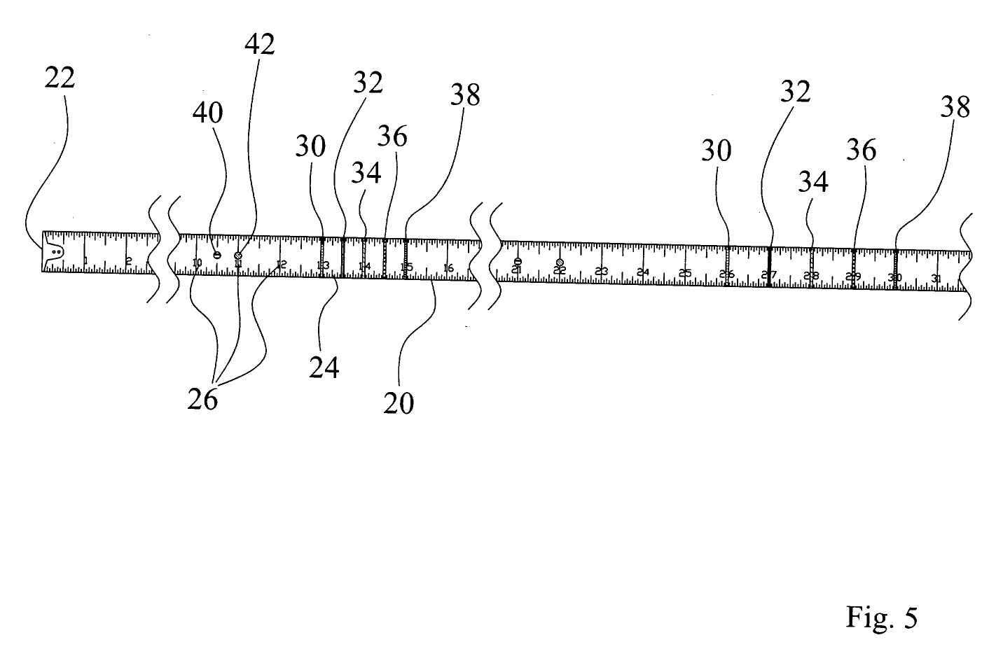

A plurality of line markings 24 and measurement markings 26 may be positioned upon the upper surface of the elongate member 20 similar to a conventional taper measure for providing a dual usage for the present invention as best shown in FIG. 5 of the drawings. A hook member 22 may be attached to the distal end of the elongate member 20 for allowing engagement with the end of the roof and tile.

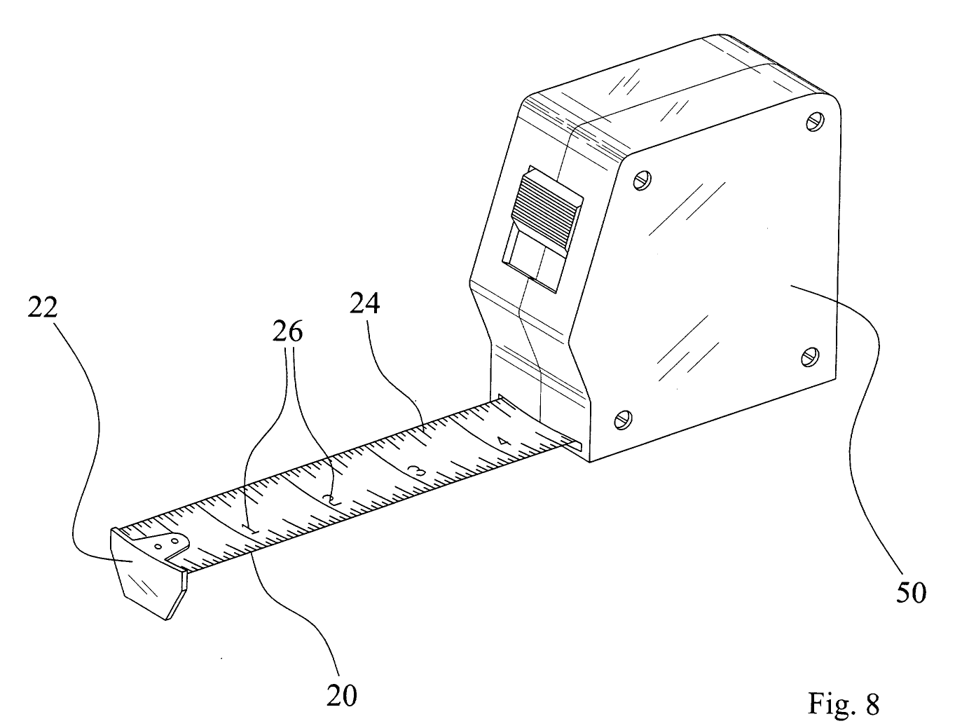

FIG. 8 illustrates an exemplary housing unit 50 which receives and dispenses the elongate member 20 in a spring coiled manner similar to conventional tape measure devices. It can be appreciated that the elongate member 20 may be utilized separate of a housing unit 50 or that various other housing units 50 may be utilized to receive and dispense the elongate member 20.

C. Horizontal Marks

FIG. 5 best illustrates the plurality of groups of horizontal marks 30, 32, 34, 36, 38 upon the elongate member 20 for use with horizontal tiles 12. Each group of the horizontal marks 30, 32, 34, 36, 38 indicates a different tile course such as but not limited to 13, 13½, 14, 14½, and 15 inches respectively. The horizontal marks 30, 32, 34, 36, 38 are repeated at the predetermined course interval (e.g. 13, 13½, 14, 14½, and 15 inches).

For example, the first group of horizontal marks 30 may each have a 13 inch spacing along the entire length of the elongate member 20 while the second group of horizontal marks 32 may each have a 13½ inch spacing along the entire length of the elongate member 20. This spacing continues for each of the remaining groups along the entire length of the elongate member 20.

FIG. 5 illustrates the horizontal marks 30, 32, 34, 36, 38 as having a line structure with a differing design or cross hatching for each group. For example, the line structure may have transverse lines at a desired spacing. Various colors and shapes may also be utilized to identify each of the specific groups of the horizontal marks 30, 32, 34, 36, 38.

D. Vertical Marks

FIG. 5 best illustrates the plurality of groups of vertical marks 40, 42 upon the elongate member 20 for use with vertical tiles 13. Each group of the vertical marks 40, 42 indicates a different tile course such as but not limited to 10½ and 11 inches respectively. The vertical marks 40, 42 are repeated at the predetermined course interval (e.g. 10½ and 11 inches).

For example, the first group of vertical marks 40 may each have a 10½ inch spacing along the entire length of the elongate member 20 while the second group of vertical marks 42 may each have a 11 inch spacing along the entire length of the elongate member 20. This spacing continues for each of the remaining groups along the entire length of the elongate member 20.

FIG. 5 illustrates the vertical marks 40, 42 as having a circular structure with a differing design or cross hatching for each group. For example, the line structure may have transverse lines at a desired spacing. Various colors and shapes may also be utilized to identify each of the specific groups of the vertical marks 40, 42

E. Operation—Horizontal Tiles

In use, the user first determines the “desired course” as specified for the roofing project such as but not limited to 13, 13½, 14, 14½, and 15 inches. The user locates the desired “group” of horizontal marks 30, 32, 34, 36, 38 which correspond to the desired course measurement which will determine the exposure of the horizontal tiles 12.

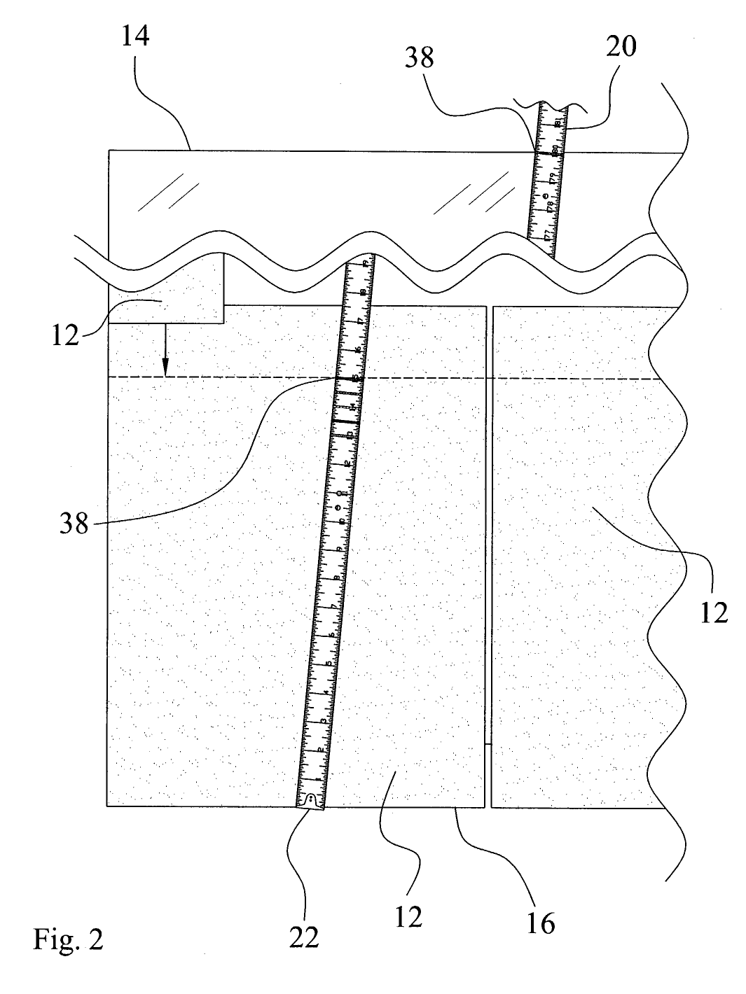

The user positions the distal end of the elongate member 20 at the second end 16 of the roof indicating the lower edge of the roof and extends the elongate member 20 to the first end 14 of the roof which is the upper edge of the roof as shown in FIG. 1 of the drawings. The user then begins to angle the elongate member 20 until one of the desired group of horizontal marks 30, 32, 34, 36, 38 is approximately upon the first end 14 of the roof as shown in FIG. 2 of the drawings. The user then marks the roof at each of the locations of the desired group of horizontal marks 30, 32, 34, 36, 38 along the entire length of the elongate member 20 thereby indicating the proper location for each course.

F. Operation—Vertical Tiles

In use, the user first determines the “desired course” as specified for the roofing project such as but not limited to 10½ and 11 inches. The user locates the desired “group” of vertical marks 40, 42 which correspond to the desired course measurement which will determine the exposure of the horizontal tiles 12.

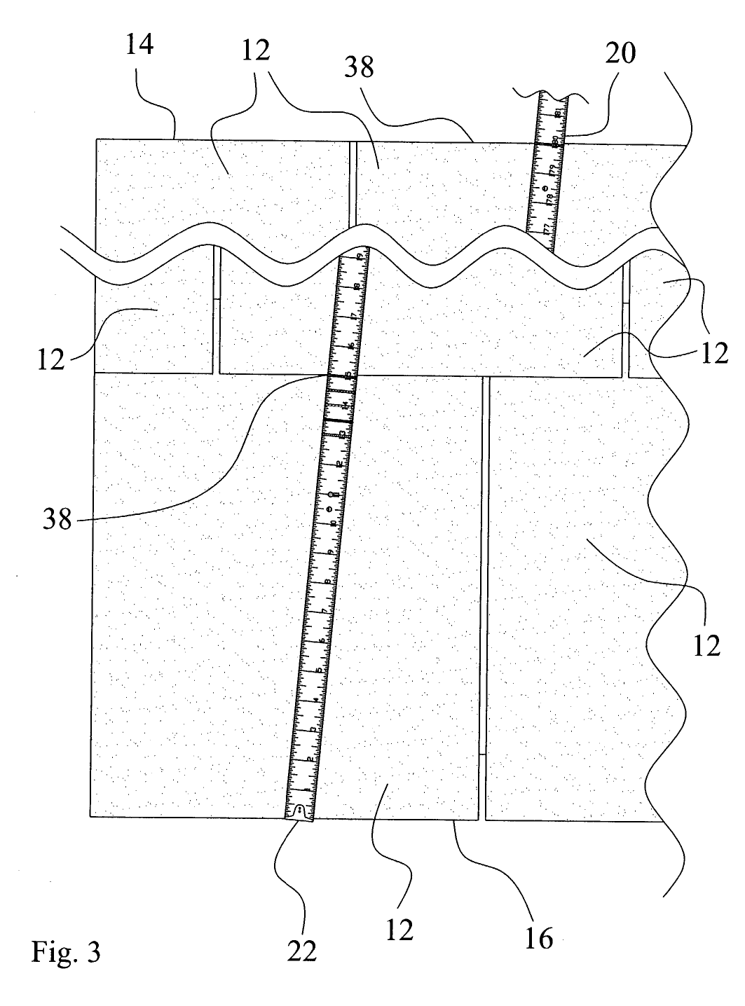

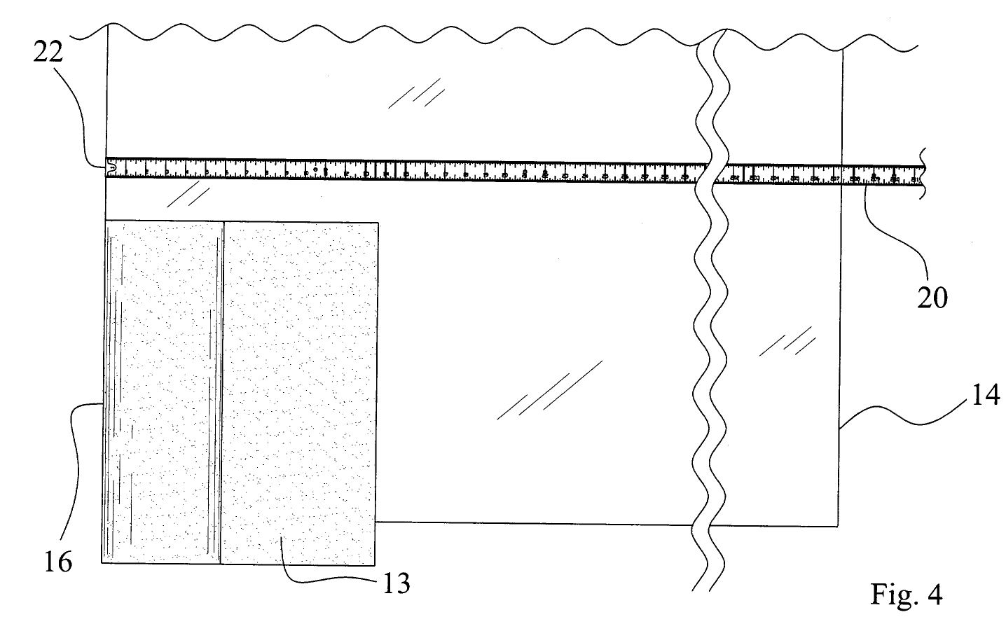

The user positions the distal end of the elongate member 20 at the second end 16 of the roof indicating the first side of the roof and extends the elongate member 20 to the first end 14 of the roof which is the second side of the roof as shown in FIG. 3 of the drawings. The user then begins to angle the elongate member 20 until one of the desired group of vertical marks 40, 42 is approximately upon the first end 14 of the roof as shown in FIG. 4 of the drawings. The user then marks the roof at each of the locations of the desired group of vertical marks 40, 42 along the entire length of the elongate member 20 thereby indicating the proper location for each course.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A roof tile measuring system, comprising:
an elongate member having a first surface; and
a plurality of markings upon said first surface of said elongate member, wherein said markings are comprised of at least one group indicating a course measurement for roof tile.

2. The roof tile measuring system of claim 1, wherein said plurality of markings are for horizontal tile.

3. The roof tile measuring system of claim 1, wherein said plurality of markings are for vertical tile.

4. The roof tile measuring system of claim 1, wherein said at least one group is comprised of a plurality of groups.

5. The roof tile measuring system of claim 4, wherein each of said plurality of groups has a unique design.

6. The roof tile measuring system of claim 5, wherein said unique design includes color.

7. The roof tile measuring system of claim 5, wherein said unique design includes shape.

8. The roof tile measuring system of claim 5, wherein said unique design includes cross hatching.

9. The roof tile measuring system of claim 4, including a plurality of horizontal groups for indicating horizontal tile measurements and a plurality of vertical groups for indicating vertical tile measurements.

10. The roof tile measuring system of claim 9, wherein said horizontal groups include a first horizontal group spaced 13 inches apart, a second horizontal group spaced 13½ inches apart, a third horizontal group spaced 14 inches apart, a fourth horizontal group spaced 14½ inches apart and a fifth horizontal group spaced 15 inches apart, and wherein said vertical groups include a first vertical group spaced 10½ inches apart and a second vertical group spaced 11 inches apart.

11. A roof tile measuring system, comprising:
a housing unit;
an elongate member having a first surface extendably positioned within said housing unit;
a plurality of line markings and a plurality of measurement markings upon said first surface of said elongate member; and
a plurality of markings upon said first surface of said elongate member, wherein said markings are comprised of at least one group indicating a course measurement for roof tile.

12. The roof tile measuring system of claim 11, wherein said plurality of markings are for horizontal tile.

13. The roof tile measuring system of claim 11, wherein said plurality of markings are for vertical tile.

14. The roof tile measuring system of claim 11, wherein said at least one group is comprised of a plurality of groups.

15. The roof tile measuring system of claim 14, wherein each of said plurality of groups has a unique design.

16. The roof tile measuring system of claim 15, wherein said unique design includes color.

17. The roof tile measuring system of claim 15, wherein said unique design includes shape.

18. The roof tile measuring system of claim 15, wherein said unique design includes cross hatching.

19. The roof tile measuring system of claim 14, including a plurality of horizontal groups for indicating horizontal tile measurements and a plurality of vertical groups for indicating vertical tile measurements, wherein said horizontal groups include a first horizontal group spaced 13 inches apart, a second horizontal group spaced 13½ inches apart, a third horizontal group spaced 14 inches apart, a fourth horizontal group spaced 14½ inches apart and a fifth horizontal group spaced 15 inches apart, and wherein said vertical groups include a first vertical group spaced 10½ inches apart and a second vertical group spaced 11 inches apart.

20. A method of utilizing a roof tile measuring apparatus, said roof tile measuring apparatus comprised of a an elongate member having a first surface, and a plurality of markings upon said first surface of said elongate member, wherein said markings are comprised of at least one group indicating a course measurement for roof tile, said method comprising:
positioning a distal end of said elongate member upon a second end of a roof;
extending said elongate member past a first end of said roof;
rotating said elongate member until one of said plurality of markings of a desired group is aligned with said first end of said roof; and
marking said roof adjacent said elongate member at each of said plurality of markings comprised of said desired group.
